(19) United States
(12) Patent Application Publication
(10) Pub. No.: US 2019/0037070 A1
(43) Pub. Date: Jan. 31, 2019

(54) METHOD FOR CALL SETUP

(71) Applicant: DIGITAL PRIVACY GMBH, 1010 Wien (AT)

(72) Inventor: Michael Walter, Wien (AT)

(21) Appl. No.: 16/080,890

(22) PCT Filed: Jan. 27, 2017
(86) PCT No.: PCT/EP2017/051758

§ 371 Date: Aug. 29, 2018

(30) Foreign Application Priority Data
Feb. 29, 2016 (EP) 16157768.9
Nov. 16, 2016 (EP) 16199080.9

(51) Int. Cl. H04M 3/42

(52) U.S. Cl. CPC H04M 3/42008; H04M 3/4228; H04M 3/42042

(57) ABSTRACT

A method for setting up a call from a subscriber comprising:
storing a first association between a first dial number and a second dial number, in a service node of a second mobile phone network;
receiving a first call which is directed to the second dial number and contains a first caller identification, in the second mobile phone network;
associating a reserve dial number of the second mobile phone network with the first caller identification and storing this association as second association to the first association in the service node;
determining the first dial number associated with the second dial number from the stored first association; and,
setting up a second call from the second mobile phone network, or another mobile or fixed phone network, to the mobile station addressed by the first dial number and connecting the first call to the second call.

### CROSS-REFERENCE TO RELATED APPLICATION(S)

This application is a National Phase application of International Application No. PCT/EP 2017/051758 filed Jan. 27, 2017 which claims priority to the European Patent Application No. 16 157 768.9 filed Feb. 29, 2016 and European Patent Application No. 16 199 080.9 filed Nov. 16, 2016, the disclosures of which are incorporated herein by reference in their entireties.

### TECHNICAL FIELD

The present subject matter relates to a method for setting up a call from a subscriber to a mobile station that is identified by a dial number in a mobile phone network.

In this description, the term “connection” or “call” shall be understood to mean a normal voice connection and even a mere signaling connection in the context of a “short message service” (SMS) from and to a mobile station, in particular according to a 2G, 4G, 5G or higher standard, such as GSM, UMTS, LTE, etc.

### BACKGROUND ART

Dial numbers in mobile phone networks are increasingly used for identifying persons, whether in address books, business cards, advertisements, etc., or as a component of login or transaction data for internet services in which an access or transaction authorization is sent by returning a password to a user's mobile telephone that has been identified by the dial number in order to assure enhanced security of the user authentication. Due to such novel uses of mobile telephone dial numbers, however, the latter are increasingly made public, and the user ultimately no longer has any true understanding of or influence on which systems or recipients have obtained his personal dial number. Not only is this contrary to the need for data protection, it also keeps many users from using beneficial internet services based on increased authentication security by confirming a mobile telephone number because they want to protect their phone numbers.

Documents GB 2 454 886 A, US 2007/0064895 A1 and WO 03/024074 A2 each illustrate a method for using anonymous dial numbers. To this end, an association data base is implemented in the home network of a mobile phone subscriber in order to replace the dial number of the mobile phone subscriber issued in this mobile phone network with an anonymous dial number. Anonymous dial numbers are therefore only available for mobile phone subscribers whose home network has implemented such an association data base.

### BRIEF SUMMARY

The object of the disclosed subject matter is to overcome these drawbacks and to create call methods for subscribers of mobile phone networks that provide enhanced protection for their dial numbers.

This object is attained according to a first aspect of the disclosed subject matter with a method for setting up a call from a subscriber having a first caller identification to a mobile station to which a first dial number in a first mobile phone network is assigned, comprising:

storing an association between the first dial number and a second dial number assigned in a second mobile phone network, in a service node of the second mobile phone network;

receiving a first call which is directed to the second dial number and contains the first caller identification, in the second mobile phone network;

if no reserve dial number is yet associated with the first caller identification in the service node, associating a yet unassociated reserve dial number from a pool of reserve dial numbers of the second mobile phone network to the first caller identification and storing this association as second association to the first association in the service node;

generating a second caller identification comprising the reserve dial number associated with the first caller identification;

determining the first dial number associated with the second dial number from the stored first association; and,

setting up a second call from the second mobile phone network, or another mobile or fixed phone network, to the mobile station addressed by the first dial number and connecting the first call to the second call, wherein the second caller identification is transmitted in the second call.

Thus the disclosed subject matter creates, as it were, a “firewall” for the user of the mobile station in the first mobile phone network by “interposing” a second mobile phone network in which a second, “virtual” dial number is associated with the subscriber. The user may forward the second, virtual dial number without worrying that he is publicly disclosing his personal, first dial number to the public. The user may use the second, virtual dial number, for instance, as a telephone contact in public advertisements or in the context of login or transaction data for internet services that, e.g., return a confirmation SMS with passwords or transaction codes via the mobile phone network while simultaneously protecting his personal, first dial number from public disclosure.

In setting up a call according to the disclosed subject matter to the second, virtual dial number, the latter is translated to the personal first dial number by the service node of the second mobile telephone network, wherein transmitted simultaneously to the called mobile station is a new (“second”) caller identification, which contains a dial number (“reserve dial number”), from the second mobile phone network, uniquely associated with the original (“first”) caller identification of the calling subscriber. Using the network prefix of the second mobile phone network contained in the reserve dial number, which is transmitted as second caller identification, the called user may now detect that the call is not his personal dial number, but instead his virtual dial number. The called user may thus decide, for example, whether or not he will answer the call directed to his virtual dial number. The disclosed method thus offers not only confidentiality and data protection, but also additional information about the calling subscriber, specifically, whether the calling subscriber has dialed the personal or the virtual dial number and thus to which private or public circle of acquaintances the calling subscriber belongs.

The use of a reserve dial number, containing the network prefix of the second mobile phone network, as caller identification in the second call further permits a data-protected call-back from the mobile station with a destination dial number containing merely this caller identification, which also functions in telephone networks that are subject to technical limitations with respect to maximum place number for the destination dial numbers that may be used for calls.

An appropriately programmed mobile station may also automatically detect the network prefix of the second mobile phone network received in the second caller identification and also especially clearly indicate to the user during signaling of the incoming call the circumstances of the use of the virtual dial numbers, e.g. on the display or with a special ringtone for the mobile station.

The second call, initiated by the service node, may be set up via the second mobile phone network itself, or via another mobile or fixed phone network, to which the service node is connected.

One particularly advantageous refinement of the disclosed method furthermore comprises:

storing at least one further association between the first dial number and a respective further second dial number assigned in the second mobile phone network, in the service node, wherein for each stored first association an association identifier is assigned;

wherein the second caller identification also comprises the association identifier.

The user of the mobile station may thus immediately use and output to different public circles a plurality of different virtual (second) dial numbers, for instance for different circles of acquaintances, different websites, different advertisements, etc. Then, at the mobile station, using the caller identification, which now also contains the association identifier for the specific called virtual dial number, not only is it possible to detect whether the caller dialed the personal or virtual dial number, but also which of the plurality of virtual dial numbers the caller used. In this way the called user obtains additional information about the public circle from which the caller comes, and may decide with even greater precision and selectivity whether or not he will take the call.

It is understood that the association identifier may also be included or defined as a part, e.g. as the last digit(s), of the reserve dial number transmitted as second caller identification. In other words, different pools of reserve dial numbers may be used in the second mobile phone network, e.g. for different virtual dial numbers of the mobile station. This embodiment also falls under the definition that the second caller identification also comprises the association identifier, specifically, in this case, in the form of an association-specific reserve dial number.

The disclosed method is especially simple to implement when the first call addressed to the second dial number is detected by means of the network prefix of the second mobile phone network and directed thereto, where it is received at a line of the second mobile phone network and from there connected to the second call. Because of this, a conventional traffic separation is sufficient based on the network prefix in order to direct the call addressed to the second dial number to the second mobile phone network.

Alternatively, the at least one virtual (second) dial number may be published in the entire telephone network and all of the mobile phone networks connected thereto in that it is registered in the home location register (HLR) of the second mobile phone network, if desired.

In the context of the disclosed method, very different call filter functions may optionally be executed in the service node for the benefit of the user of the mobile station. To this end the second call may only be set up and the first call only be connected to the second call when the first caller identification is included in an admission list (“whitelist”) or is not included in a blocking (“blacklist”), the admission list or blocking list, respectively, being stored in the service node with respect to the first dial number. In this way the user of the mobile station may be protected from undesired calls (“blacklisting”) or only desired calls are put through (“whitelisting”).

If the user of the mobile station has a plurality of virtual dial numbers, in this context the second call may also only be set up and the first call may only be connected if the first caller identification is contained in such an admission list or is not contained in such a blocking list that is stored in the service node for the first dial number.

The disclosed method also permits at any time a call-back from the mobile station called on the virtual dial number to the original caller, because its caller identification is not lost. Thus, in a second aspect, the disclosed subject matter also relates to a method for calling back of the subscriber from the mobile station, i.e., following a call method according to the first aspect of the disclosed subject matter, comprising:

receiving a third call which contains the second caller identification as destination dial number and the first dial number as third caller identification, in the second mobile phone network;

extracting the reserve dial number from the destination dial number;

determining the first caller identification associated with the reserve dial number from the stored second association of that first association that contains the first dial number;

setting up a fourth call from the second mobile phone network, or a further mobile or fixed phone network, to the subscriber addressed by the determined first caller identification and connecting the third call to the fourth call.

The method here optionally also comprises determining the second dial number associated with the first dial number from the first association stored in the service node and generating a fourth caller identification comprising the determined second dial number; wherein the fourth caller identification is transmitted in the fourth call.

In this way the called-back subscriber again obtains as caller identification the virtual, second dial number of the user of the mobile station, and his personal, first dial number remains hidden and protected. The called-back subscriber sees only the virtual dial number originally called by him and detects this as a normal call-back of the user of the mobile station.

In the embodiment of the call method according to the first aspect of the disclosed subject matter in which a plurality of virtual dial numbers are associated in the second mobile phone network and an association identifier is assigned to each association, a further embodiment of the call-back method furthermore is distinguished in that:

during the step of extraction also the association identifier is extracted from the destination dial number; and,

during the step of generating the fourth caller identification, the second dial number associated with the first dial number is determined by means of the first association identified by the extracted association identifier.

Here, as well, during the call-back it is precisely the virtual dial number used by the original caller that is signaled as the caller identification of the person calling back, so that the call-back appears consistent and transparent for the person called back without the personal dial number of the user of the mobile stations being publicly disclosed.

It is understood that if the association identifier was “integrated” into the reserve dial number, e.g. an association-specific pool of reserve dial numbers was used, the steps of extracting the association identifier from the destination dial number and of determining the second dial number identified thereby then simply mean searching for that first association for which the specific pool of reserve dial numbers was used; this embodiment, as well, is included by the definition “extracting the association identifier from the destination dial number” and “determining the second dial number by means of the first association identified by the extracted association identifier.”

During call-back of the subscriber from the mobile station, the third call of the mobile station directed to the second caller identification as destination dial number may be detected by means of the network prefix contained in the reserve dial number and directed thereto, where it is received at a line of the second mobile phone network and from there is connected to the fourth call, so that for this only a traffic separation using the network prefix of the second mobile phone network is sufficient.

According to another embodiment of the disclosed subject matter, the second associations stored in the service node for a first association are sent via a data connection to the mobile station and there are stored in a memory of the mobile station. In this way, for example, an appropriately programmed application in the mobile station may perform the automatic translation of a reserve dial number, contained as caller identification, to the original caller identification of the calling subscriber.

One advantageous use of this embodiment optionally comprises:

extracting the reserve dial number from the second caller identification transmitted in a second call, in the mobile station;

determining the first caller identification associated with the extracted reserve dial number in a second association from the memory; and,

indicating the first caller identification in the mobile station.

In this way the method becomes transparent for the user of the mobile station, as well, since he now also obtains information about the “true”, original caller identification of the caller. To this end, optionally a continuous comparison is conducted of the second associations stored in the service node between original caller identifications and reserve dial numbers, on the one hand, and a copy of these second associations in the memory of the mobile station, on the other hand, via the aforesaid data connection. The data connection may be a mobile Internet connection of the mobile station, for example, that it maintains to the service node in the background, for example via a 3G, 4G, or 5G data connection, regardless of the described calling in the telephone network.

The at least one virtual second dial number may be a dial number directly assigned in the second mobile phone network, or may also be a dial number that has been dial number ported into the second mobile phone network from a further mobile phone network. It is understood that such dial number porting means that this virtual second dial number must be entered in the HLR of the other mobile phone network from which porting occurred as the ported dial number, such as e.g. is defined in the case of a GSM network in the corresponding ETSI standards about dial number porting.

In each of the described variants of the method, the second mobile phone network may be a conventional, hardware-based mobile phone network (“Mobile Network Operator”, MNO), or alternatively may be virtualized as a “Mobile Virtual Network Operator” (MVNO) in a third, hardware-based MNO mobile phone network.

### BRIEF DESCRIPTION OF THE DRAWINGS/FIGURES

The disclosed subject matter shall be explained in greater detail in the following using exemplary embodiments depicted in the attached drawings, in which:

FIGS. 1 and 2 depict the methods according to the disclosed subject matter using a call set-up of a calling subscriber to a called mobile station (FIG. 1), and in the opposite direction as a call-back (FIG. 2), in each case in the form of a schematic block diagram with illustrated call set-up signal flows;

FIGS. 3 and 4 each depict variants of the methods from FIGS. 1 and 2 in the same manner, and,

FIG. 5 depicts further variants of the methods in FIGS. 1 through 4 in the same manner.

### DETAILED DESCRIPTION

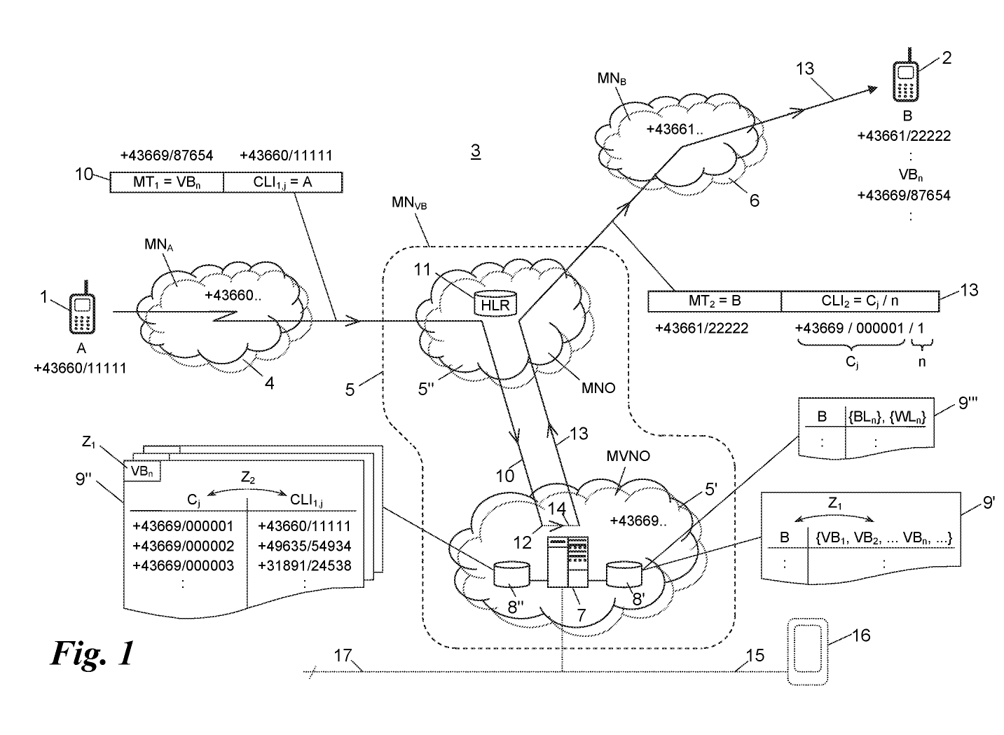

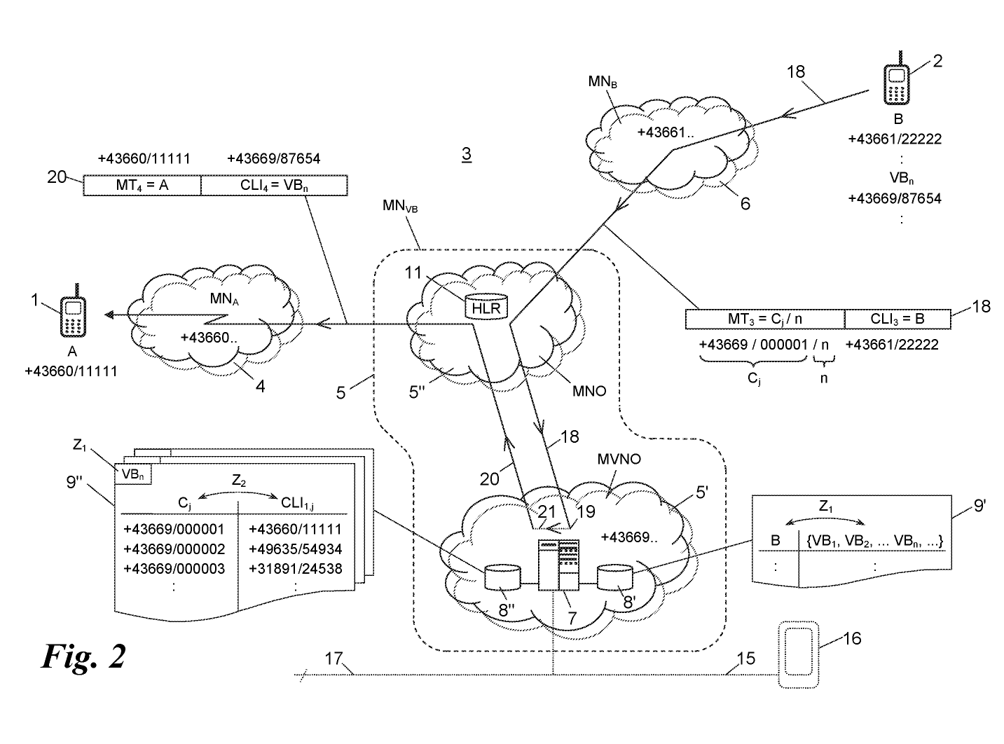

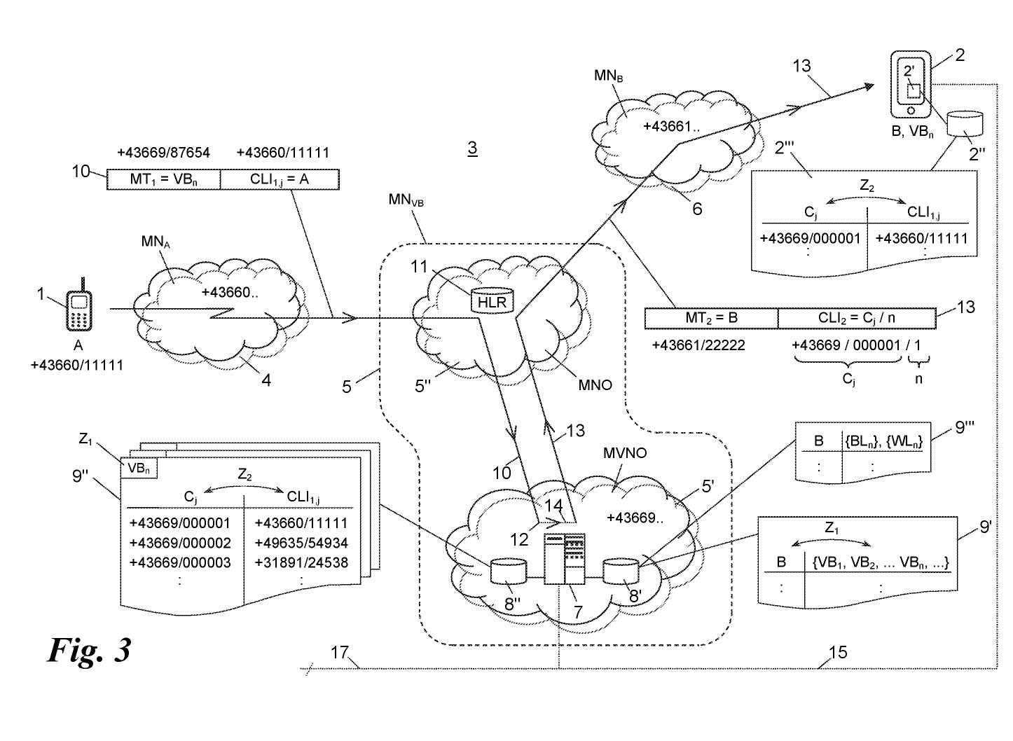

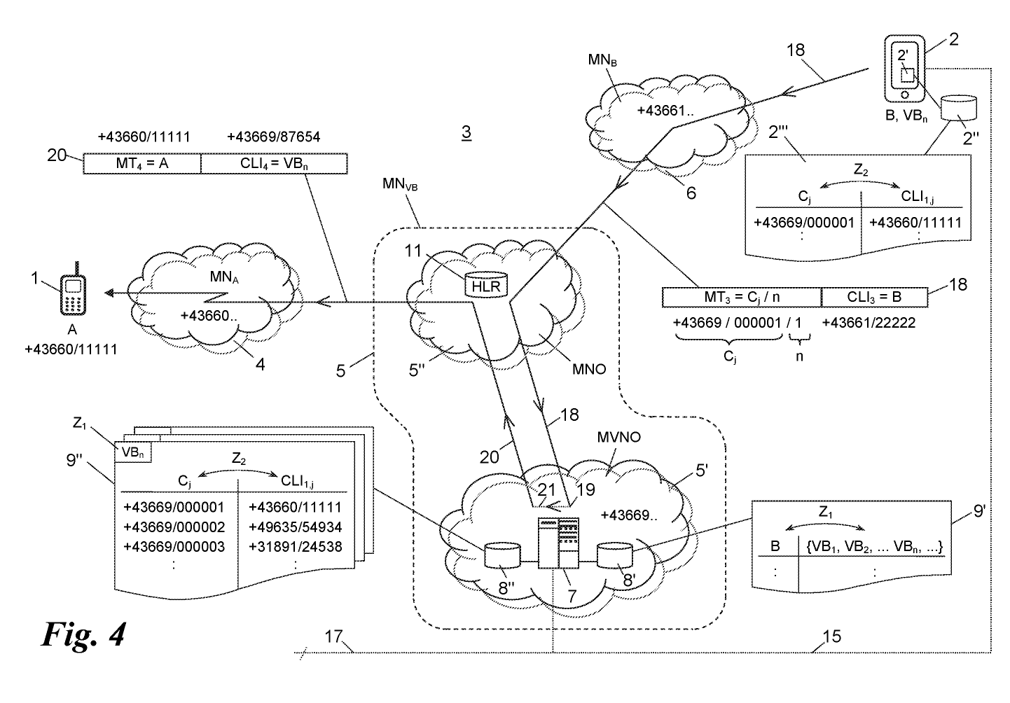

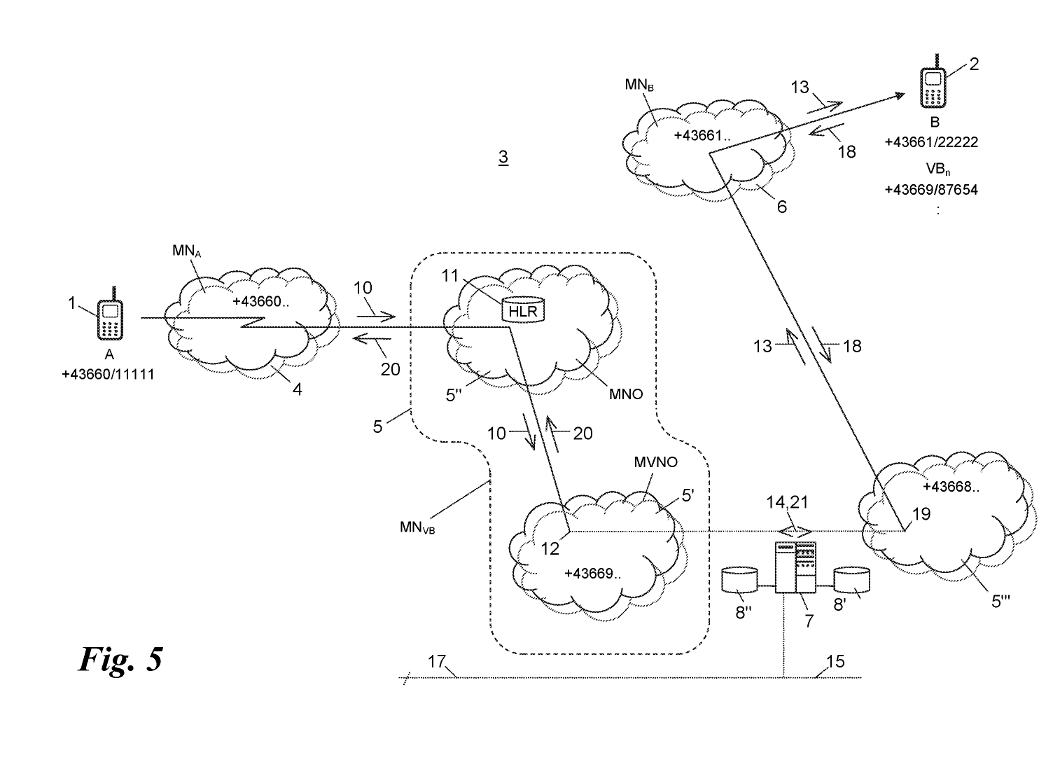

FIGS. 1 through 5 depict methods for connecting a first subscriber 1 to a second subscriber 2 via a telephone network 3, which is composed of a number of mobile or fixed phone networks connected to one another, of which three mobile phone networks 4, 5 and 6 are depicted as an example. FIGS. 1 and 3 are methods for setting up a call from the calling subscriber 1 to the called subscriber 2, FIGS. 2 and 4 depict the method for setting up a call from subscriber 2, now calling, to subscriber 1, now called, and FIG. 5 depicts variants of the methods from FIGS. 1 through 4.

The network 6 of the subscriber 2 is a mobile phone network using a 2G, 3G, 4G, 5G, or higher standard, such as GSM, UMTS, LTE, or the like. The subscriber 2 in the mobile network 6 is consequently a mobile station, for example a mobile telephone, a smartphone, etc.

The mobile phone network 6 may be addressed in the entire telephone network 3 via its network prefix MN_{B}, in the present example the network prefix “+43661.” The subscriber or the mobile station 2 may be addressed in the telephone network 3 using his/its dial number B, which includes the network prefix MN_{B}, in the present example the dial number “+43661/22222.” This dial number B assigned to the mobile station 2 in the mobile phone network 6 is also referred to in the following as the “first” or “personal” dial number of the mobile station 2.

Similarly, the subscriber 1, in the illustrated example again a mobile station in a mobile phone network 4 having the network prefix MN_{A}, e.g., “+43660,” is identified by his or its dial number A, in this case “+43660/11111.” For the purposes of the present method, however, it is not necessary for the network 4 to be a mobile phone network and the subscriber 1 to be a mobile station; the network 4 of the subscriber 1 could also be a fixed phone network (“Plain Old Telephone System”, POTS) having the capability of transmitting caller line identifications (CLI), or could be a VoIP (Voice over IP) network connected to the telephone network 3 and in which the subscriber 1 is e.g. an internet telephone or internet terminal.

The network 5 of the telephone network 3 connecting the networks 4 and 6 in the call and call-back situations in FIGS. 1 through 5 is itself, like the mobile phone network 6 of the mobile station 2, a mobile phone network according to a 2G, 3G, 4G, 5G, or higher standard, such as GSM, UMTS, LTE, and the like. The mobile phone network 5 may be addressed in the telephone network 3 by its network prefix MN_{VB}, in the present example the network prefix “+43669.” The mobile phone network 5 is also referred to as the “second” mobile phone network in the following.

In the example shown, the mobile phone network 5 is implemented in the form of a “Mobile Virtual Network Operator” (MVNO) 5′ in a third mobile phone network 5″ (“virtualized”) that provides the hardware infrastructure for the MVNO network 5′. The task distribution between MVNO network 5′ and MNO network 5″ of the mobile phone network 5 may be different depending on the degree of virtualization or portion of infrastructure that the MNO network 5″ provides for the MVNO network 5′, as it is known as virtualization steps “thick,” “thin” and “skinny,” or “full” and “light” for MVNOs in engineering. However, it is understood that the mobile phone network 5 may also be realized without virtualization division into the networks 5′ and 5″ using a single mobile phone network according to the aforesaid standards.

The mobile phone network 5 contains at least one service node 7 having data bases 8′ and 8″ integrated therein or attached thereto. It is understood that the data bases 8′ and 8″ may also be realized using a common data base. The service node 7 in the example shown is registered in the MVNO network 5′, but may alternatively also be registered in the infrastructure-providing MNO network 5″, or may also be distributed across both networks 5′, 5″. In a mobile phone network 5 according to the GSM, UMTS or LTE standard, the service node 7 is implemented for example in the central Mobile Services Switching Center (MSC) of the mobile phone network 5 or is connected thereto via a data connection.

To protect the personal dial number B of the mobile station 2 from calling or called subscribers such as the subscriber 1, the following steps are executed using the components depicted.

In a first step preceding the call from the subscriber 1 to the mobile station 2 (or vice versa), one or more second, “virtual” dial numbers VB₁, VB₂, . . . , in general VBₙ, are associated with the mobile station 2, more specifically to its first, personal dial number B, in the second mobile phone network 5. The dial number “+43669/87654” is used here as an example of such a virtual dial number VBₙ in the second mobile phone network 5. This association B↔VBₙ cited here as “first” association Z₁ is stored in the data base 8′ of the service node 7 of the mobile phone network 5 in an association table 9′. Each first association Z₁, i.e. B↔VB₁, B↔VB₂, . . . B↔VBₙ, . . . is simultaneously identified by its association identifier 1, 2, . . . , in general n. It is understood that in the simplest case of only a single association Z₁=B↔VB the association identifier n is not necessary and may be omitted.

The virtual dial number VBₙ may be published by the user of mobile station 2 without any misgivings and forwarded to third parties, e.g. to the subscriber 1, since the mobile phone network 5 and the further steps of the described method protect or anonymize his personal dial number B in the mobile phone network 6. If the subscriber 1 wants to call the mobile station 2, he dials the virtual dial number VBₙ that was made known to him by the user and that contains the network prefix MN_{VB} of the second mobile phone network 5 as the prefix. This sets up a first call 10 from the subscriber 1 to the mobile phone network 5, which as destination dial number (Mobile Target) MT₁ contains the nth virtual dial number VBₙ of the mobile station 2 and as caller identification (Caller Line Identification) CLI₁ contains the dial number A of the subscriber 1.

Since in successive calls 10 different subscribers 1 having different dial numbers may call one and the same mobile station 2, furthermore the index j (j=1, 2, . . . ) is used for differentiating different first caller identifications CLI_{1,j} of such different subscribers 1.

The first call 10 is directed in the telephone network 3 to the mobile telephone network 5 by means of the network prefix NM_{VB} (separated from traffic). Alternatively, the virtual dial number VBₙ may have been made known in the telephone network 3, e.g. by feeding it into a Home Location Register (HLR) 11 of the mobile phone network 5. In GSM, UMTS, or LTE networks, such an entry in the HLR is distributed in a standard conforming manner in the telephone network 3 or to all mobile phone networks contained therein in order to display the home of the dial number VBₙ in the mobile phone network 5 and thus to display its jurisdiction so that the call 10 is directed to the mobile phone network 5.

The call 10 is received or terminated in the mobile radio network 5 at an internal or virtual line 12 thereof, with the involvement of the service node 7. The service node 7 now extracts from the destination dial number MT₁ contained in the signaling of the first call 10 the virtual dial number VBₙ, looks the latter up in the association table 9′, and determines therefrom the associated personal dial number B, as well as (if a plurality of virtual dial numbers VBₙ are associated with it), the identifier n for the specific first association Z₁=VBₙ↔B. In addition, the service node 7 generates a new (“second”) caller identification CLI₂ as described in the following.

To this end, reserved in the mobile phone network 5 is a pool of dial numbers, called “reserve dial numbers” C₁, C₂, . . . , Cⱼ, . . . , that each include the network prefix MN_{VB} of the mobile phone network 5. Since the network prefix MN_{VB} of the mobile phone network 5 is known and is the same for all reserve dial numbers Cⱼ, it is sufficient to store the remaining digits of the reserve dial numbers in the pool. In the example shown, the dial number block +43669/000001 to +43669/009999 is reserved in the mobile phone network 5 for reserve dial numbers q. Furthermore, one further association table 9″ is set up in the service node 7, for example in its second data base 8″, for each possible first association Z₁, i.e. per association B↔VB₁, B↔VB₂, . . . , B↔VBₙ, . . . .

If a first call 10 having a first caller identification CLI_{1,j} now enters in the second mobile phone network 5, more specifically on the line 12, a new entry is made in the association table 9″ set up for the corresponding first association Z₁ (this is identified by the destination dial number MT₁=VBₙ), which entry contains an association Z₂ (here called the “second” association) between the caller identification CLI_{1,j} and a thus far yet unassociated (free) reserve dial number Cⱼ from the pool, i.e. Z₂=CLI_{1,j}↔Cⱼ.

It is understood that when the call 10 arrives, first the table 9″ is consulted to determine whether a second association Z₂ is already available for the received caller identification CLI_{1,j}; if so, the available association Z₂ is used in order not to generate unnecessary entries in the table 9″ and in order not to use unnecessarily reserve dial numbers from the pool.

If at a later point in time another call 10 from another subscriber having another dial number A for the same mobile station 2 arrives, i.e., having a different first caller identification CLI_{1,j} for which there is still no association Z₂ in the table 9″, a different, thus far unassociated reserve dial number from the pool of available reserve dial numbers of the mobile phone network 5 is associated with this new caller identification CLI_{1,j}, i.e. a new association Z₂ is stored in the table 9″.

A separate table 9″ may be set up for each first association Z₁, i.e. for each virtual dial number VBₙ. Alternatively a single table 9″ may be used that has an additional column in which the specific virtual dial number VBₙ, i.e. first association Z₁, may also be stored for association CL_{1,j}↔Cⱼ. Likewise, it would be possible to reserve, for different association identifiers n of the first association Z₁, different regions or sub-blocks of the pool of reserve dial numbers of the mobile phone network 5, so that, for example, it is possible to deduce the corresponding first association Z₁=B↔VBₙ simply from knowing the sub-block in which the specific reserve dial number of an association Z₂ is disposed. Also, it makes no difference whether the second association Z₂ in the data base(s) 8′, 8″ are linked to the virtual dial number VBₙ, the first association Z₁, or the association identifier n, or whether the reserve dial number removed from an association-specific sub-block of the pool therein itself represents the association identifier n, in order to produce the connection between a first association Z₁, i.e. the called mobile station 2, and a second association Z₂ stored therefor, i.e. the calling subscriber 1; all of these variants are equivalent in terms of data technology. Thus, in the simplest case, even only a single data base 8′ or 8″ may be used in the service node 7 in which all of these associations Z₁, Z₂ are stored, cross-referenced with minimum redundancy.

The second caller identification CLI₂ is now generated based on the second association Z₂. In the simplest case, the second caller identification CLI₂ corresponds to the reserve dial number Cⱼ associated with the first caller identification CLI_{1,j} in the association Z₂. This is also true if a specific reserve dial number was used for the specific virtual dial number VBₙ. In another embodiment, the second caller identification CLI₂ may also have the specific association identifier n of the first association Z₁=B↔VBₙ, in addition to the reserve dial number Cⱼ.

Then the service node 7 initiates the set-up of a second call 13 proceeding from the mobile phone network 5 to the mobile station 2, in the mobile network 6, identified by the dial number B. The destination dial number MT₂ of the second call 13 is the dial number B, and the newly generated second caller identification CLI₂ is transmitted as caller identification.

Once the second call 13 has been set up (or even during it), the service node 7 connects the first call 10 that terminates in the mobile phone network 5 to the second call 13, i.e., it connects the voice data for the first call 10 to the voice data for the second call 13 or forwards SMS data from the first call 10 as SMS data in the second call 13 (see the connection 14).

While the first call 10 is being received, the second call 13 is being set up, and/or the connection 14 from the first call 10 to the second call 13 is being established, the service node 7 may also conduct filter functions with respect to caller identifications CLI₁ desired or not desired by the user of the mobile station 2, so-called “whitelisting” or “blacklisting,” in order to protect the user of the mobile station 2 from undesired calls or to connect only desired calls. To this end, one (or more) admission lists (“whitelists”) WLₙ of first caller identifications CLI_{1,j} (dial numbers A) that are supposed to be connected (all others are blocked) may be stored in the service node 7 or its data base 8′ or 8″ for the personal dial number B of the mobile station 2, or one (or more) blocking lists (“blacklists”) BLₙ of such first caller identifications CLI_{1,j} (dial numbers A) that are not permitted to be connected (all others are connected), i.e., for which no connection 14 is made and consequently no second call 13 has to be set up either.

In the case of a plurality of virtual dial numbers VBₙ, different admission lists WLₙ and blocking lists BLₙ may also be used, and specifically depending on a determined association n, as results from the virtual dial number VBₙ dialed by the subscriber 1. In this case, then, the admission list WLₙ or blocking list BLₙ associated with the dialed virtual dial number VBₙ is selected from the data base 8′ or 8″ and then there is a check of whether the caller identification CLI_{1,j} of the first call 10 is contained therein or not. Only if it is contained in the admission list WLₙ and is not contained in the blocking list BLₙ is the second call 13 set up and the first call 10 connected to the second call 13 (connection 14); otherwise, the first call 10 remains terminated on the line 12 of the mobile phone network 5 or is aborted. Optionally, the calling subscriber 1 may also obtain a corresponding voice message that the service node 7 adds to the line 12.

The admission lists WLₙ and/or blocking lists BLₙ may be stored in a discrete association table 9′″ of the service node 7 or its data base 8′, 8″, or in the same association table 9′ in which the first associations Z₁ are also stored; or even in the association table 9″ of the second associations Z₁; for example, the specific list WLₙ and/or BLₙ could be stored with every individual association Z₁.

In the method presented, such “blacklisting” or “whitelisting” even functions for calls 10 from the subscriber 1 that are set up with a “dial number suppression.” According to conventional CLI telephone standards, such a dial number suppression does not remove the caller identification CLI_{1,j} from the call 10, but rather identifies the caller identification CLI₁, in the call 10 merely with a flag as “suppressed”; the flag is normally not evaluated until in the last sub-network of the telephone network 3 when the call is provided to the called subscriber and there then suppresses the caller identification. The caller identification CLI_{1,j} is thus in any case still available in the interposing mobile phone network 5 and therefore in the service node 7 and may be evaluated for the aforesaid blacklisting and whitelisting functions.

Since each call 13 that comes into the mobile station 2 is detectable by the network prefix MN_{VB} of the mobile phone network 5 contained in the second caller identification CLI₂, which is part of the reserve dial number q, as a call directed to the virtual dial number VBₙ of the mobile station 2, the user of the mobile station 2 may also decide, using the caller identification CLI₂, whether or not he wants to receive such a call. If the mobile station 2 has a plurality of virtual dial numbers VBₙ, using the association identifier n also transmitted, which is also merely a component of the reserve dial number Cⱼ if it indicates its belonging to a sub-block of the pool, the user may also detect the specific public circle to which he disclosed the specific virtual dial number VBₙ.

The mobile station 2 may also be programmed e.g. as a smartphone such that it automatically detects the network prefix MN_{VB} of the mobile phone network 5 in the caller identification CLI₂ and to this end executes special processing steps for such a call, e.g. a special visual or acoustic signaling, a unique graphic display of the association identifier n, a special recording of the call, an individual voice message of a responder to a call, etc.

Such individual voice messages for the specifically dialed virtual dial number VBₙ may also already be added by the service node 7 itself into the line 12 terminating the first call 10, e.g. if the user of the mobile station 2 does not answer the second call 13 within a defined period of time, misses the call, or intentionally does not pick up. Such an individual voice message or call response function, i.e., depending on the dialed virtual dial number VBₙ, may therefore be performed both using the association identifier n contained in the caller identification CLI₂ and directly in the service node 7 using the dial number VBₙ contained in the destination dial number MT₁.

Via an (optional) data connection 15, the user of the mobile station 2 may also administer all of his virtual dial numbers VBₙ in the mobile phone network 5 himself, e.g. register (retrieve), deactivate or delete, etc., for example from an Internet terminal 16. The terminal 16 may be formed directly by the mobile station 2, as well, for instance if the mobile station 2 is an Internet-capable smartphone if it has a data connection 15 to the mobile phone network 5 or its service node 7. The user may also manage the admission lists WLₙ and blocking lists BLₙ for the filter functions of the service node 7 via the data connection 15 and the Internet terminal 16 (or a corresponding terminal application in the mobile station 2).

To satisfy all types of regulatory terms with respect to traceability of connections, the service node 7 may also optionally have an enforcement interface 17 for authorities to have access to the association table 9.

FIG. 2 depicts the method for setting up a call-back from the mobile station 2 to the subscriber 1. The call-back situation shall be explained using the second caller identification CLI₂, which was obtained in the mobile station 2 during the course of the second call 13 from FIG. 1.

In the call-back, the second caller identification CLI₂ is used as a new destination dial number MT₃ in a third call 18. Due to the use of the reserve destination dial number q instead of the first caller identification CLI_{1,j}, which would also contain the network prefix MN_{A} of the mobile phone network 4 and which, if included in the second caller identification CLI₂ would therefore lead to a significant place length for the second caller identification CLI₂, especially if it also still contains the network prefix MN_{VB} of the mobile phone network 5, the place length of the second caller identification CLI₂ and thus of the destination dial number MT₂ may be kept short. Because of this, the third call 18 may even be performed in telephone networks 3 that are subject to technical limitations with respect to the maximum place length of destination target numbers.

Using the network prefix MN_{VB} of the mobile phone network 5 contained in the destination dial number MT₃, the third call 18 is directed in the telephone network 3 to the mobile phone network 5 (separated from traffic) and there is terminated again using the service node 7 on an internal or virtual line 19 of the mobile phone network 5.

The service node 7 now extracts the dial number contained in the destination dial number MT₃ and looks it up in the table 9″ of those second associations Z₂ which are applied for such a first association Z₁ in which is contained the “true” first dial number B of the mobile station 2 transmitted in the caller identification CLI₃. If the destination dial number MT₃ dialed in the call 18 contained not only the reserve dial number but also the association identifier n, the first association Z₁ referenced by the association identifier n, and table 9″ belonging thereto of second associations Z₂, is used. On the other hand, if the reserve dial number was already assigned association-specific for such an “nth” association Z₁=B↔VBₙ, it is sufficient to look for the first association Z₁ referenced by the caller identification CLI₃=B and thus its global table 9″ of second associations Z₂ of such association-specific reserve dial numbers q.

Now, from the determined association Z₂, there is a search for the first caller identification CLI_{1,j} entered there; it corresponds to the dial number A of the subscriber 1, and the service node 7 now sets up a fourth call 20 from the mobile phone network 5 to the subscriber 1 with the destination dial number MT₄=A=CLI_{1,j}. After the call has been set up, the service node 7 connects the third call 18 to the fourth call 20 in terms of the voice or SMS data transported therein (see connection 21).

The fourth call 20 may either occur with suppressed caller identification, or, optionally, may contain a new, fourth caller identification CLI₄ that the service node 7 generated as follows. From the caller identification CLI₃ that was transmitted by the mobile station 2 in the third call 18 and that is the same as the personal dial number B of the mobile station 2, and, optionally, the association identifier n contained in the destination dial number MT₃ or implicitly referenced by the reserve number q, the service node 7 searches the association table 9 for the first association Z₁=B identified by the association identifier n (or, if there is no association identifier, the single first association Z₁=B↔VB) and uses the virtual dial number VBₙ (or VB) determined in this way as the new caller identification CLI₄ in the fourth call 20.

The user on the end device 1 thus is signaled with a call-back 20 that indicates as the caller identification CLI₄ precisely the virtual dial number VBₙ that he used early in his first call (FIG. 1). The call and call-back method in FIGS. 1 and 2 is therefore completely transparent for the subscriber 1, without revealing the personal dial number B of the mobile station 2, and also permits a data-protected call-back from the mobile station 2 to the subscriber 1.

FIGS. 3 and 4 each depict a variant of the methods according to FIGS. 1 and 2, wherein in the following only the differences from FIGS. 1 and 2 shall be explained.

As is shown in FIGS. 3 and 4, an appropriately programmed application 2′ of the mobile station 2 in a memory 2″ of the mobile station may maintain a discrete table or copy 2′″ of the second associations Z₂=CLI_{1,j}↔Cⱼ. Via the data connection 15, the application 2′ maintains the table 2′″ as much as possible synchronous to the table 9″ in the service node 7, i.e., updates using corresponding exchange of data packets via the data connection 15 depending on availability of the data connection and if there are changes in the table 9″ its own copy 2′″ of the table 9″. The mobile station 2 or its application 2′ now has a specific current copy 2′″ of the table 9″ of second associations Z₂ of the service node 7, to the extent this corresponds to the options for the data connection 15.

If now the second call 13 with the second caller identification CLI₂, which comprises the reserve dial number contained in the association Z₂, is received, the application 2′ can search its memory 2″ for the first caller identification CLI_{1,j} associated with the reserve dial number Cⱼ in its local copy 2′″ of associations Z₂, and thus the dial number A of the calling subscriber 1, and display it for instance on a screen of the mobile station 2 of the user. The application 2′ may also optionally perform further processing steps based on the first caller identification CLI_{1,j} or dial number, such as using a special ringtone, recorded message, or call response, treatment in whitelists or blacklists, etc.

Moreover, during the call-back (FIG. 4), the application 2′ may display to the user the dial number A of the subscriber 1 to be called back, or the user may “dial” the caller identification CLI_{1,j}=A stored in the table 2′″ of the memory 2′ of the mobile station 2 directly with the application 2′, whereupon the application 2′ translates the caller identification CLI_{1,j} or dial number A using the local copy 2′″ of the association table 9″ to the destination dial number MT₃=Cⱼ to be used for the call 18, optionally with the addition of the association identifier n.

In the case of a plurality of virtual dial numbers VBₙ, the application 2′ may also offer the user a dial option for the desired virtual dial number VBₙ that is to signal the subscriber 1 as caller identification CLI₄, for instance in the form of the specific association identifier n which the user of the mobile station 2 selects for the call to be actuated in the application 2′.

FIG. 5 depicts further alternative embodiments of the methods from FIGS. 1 through 4, wherein here, for better understanding, only the subscribers, networks, and call connections involved are illustrated, but both for the call situation in FIGS. 1 and 3 and the call-back situation in FIGS. 2 and 4. Provided there is no description to the contrary in the following, all components, functions, and method processes in FIG. 5 are as described in the foregoing for FIGS. 1 through 4.

According to FIG. 5, when a call from the subscriber 1 to the subscriber 2 is being set up, the second call 13 is also set up via a different mobile or fixed phone network 5′″. In the example shown, this other or further network 5′″ is a mobile phone network having, as an example here, the network prefix “+43668.” It is understood that the further network 5′″ like the mobile phone network 5 may likewise be virtualized as an MVNO in a MNO mobile phone network.

The service node 7 is connected both to the second mobile phone network 5 and to the further network 5′″ and may thus connect the call 10 arriving in the mobile phone network 5 on the line 12 via the connection 14 to the second call 13 set up by the further network 5′″.

In the reverse situation of the call-back from the subscriber 2 to the subscriber 1, as well, the third call 13 may be received on a line 19 of the further network 5′″ and connected to the fourth call 20 by the service node 7 via the connection 21.

The home of service node 7 here may be in the mobile phone network 5, whether this is in the MVNO network 5′ or in the infrastructure-providing MNO network 5″, and in the further network 5′″, or may even be distributed across both networks 5, 5′″, including any MVNO and MNO networks implementing them. In mobile phone networks 5, 5′″ according to the GSM, UMTS, or LTE standard, the service node 7 may be implemented for example in a central Mobile Services Switching Center (MSC) of one of the networks 5, 5′″ and connected to the Mobile Services Switching Center of the other network 5′″, 5 via a data connection, or it is separated from the MSC of the networks 5, 5′″ and each is connected thereto via a data connection. The functionality of the service node 7 may also be jointly realized using one or a plurality of the MSCs or subsequent tasks.

### CONCLUSION

The disclosed subject matter is not limited to the illustrated embodiments, but instead includes all variants, modifications, and combinations thereof that fall within the scope of the attached claims.

1. A method for setting up a call from a subscriber having a first caller identification to a mobile station to which a first dial number in a first mobile phone network is assigned, comprising:
storing a first association between the first dial number and a second dial number assigned in a second mobile phone network, in a service node of the second mobile phone network;
receiving a first call which is directed to the second dial number and contains the first caller identification, in the second mobile phone network;
if no reserve dial number is yet associated with the first caller identification in the service node, associating a yet unassociated reserve dial number from a pool of reserve dial numbers of the second mobile phone network with the first caller identification and storing this association as second association to the first association in the service node;
generating a second caller identification comprising the reserve dial number associated with the first caller identification;
determining the first dial number associated with the second dial number from the stored first association; and,
setting up a second call from the second mobile phone network, or another mobile or fixed phone network, to the mobile station addressed by the first dial number and connecting the first call to the second call, wherein the second caller identification is transmitted in the second call.

2. The method according to claim 1, further comprising:
storing at least one further association between the first dial number and a respective further second dial number assigned in the second mobile phone network, in the service node, wherein for each stored first association an association identifier is assigned;
wherein the second caller identification also comprises the association identifier.

3. The method according to claim 1, wherein the first call addressed to the second dial number is detected by means of the network prefix of the second mobile phone network and directed thereto, where it is received at a line of the second mobile phone network and from there is connected to the second call.

4. The method according to claim 1, wherein the second dial number is registered in the home location register of the second mobile phone network, and in that the first call addressed to the second dial number is directed by means of the home location register, or information derived therefrom, to the second mobile phone network, where it is received at a line of the second mobile phone network and from there is connected to the second call.

5. The method according to claim 1, wherein the second call is only set up and the first call is only connected when the first caller identification is included in an admission list or not included in a blocking list, the admission list or blocking list, respectively, being stored in the service node with respect to the first dial number.

6. The method according to claim 5, further comprising:
storing at least one further association between the first dial number and a respective further second dial number assigned in the second mobile phone network, in the service node, wherein for each stored first association an association identifier is assigned;
wherein the second caller identification also comprises the association identifier; and
wherein for each second dial number associated with a first dial number an individual admission or blocking list is stored in the service node, wherein the respective admission or blocking list to be applied is determined by means of that second dial number is directed.

7. The method according to claim 1, furthermore for subsequent calling back of the subscriber from the mobile station, comprising:
receiving a third call that contains the second caller identification as destination dial number and the first dial number as third caller identification, in the second mobile phone network;
extracting the reserve dial number from the destination dial number;
determining the first caller identification associated with the reserve dial number from the stored second association of that first association that contains the first dial number;
setting up a fourth call from the second mobile phone network, or another mobile or fixed phone network, to the subscriber addressed by the determined first caller identification and connecting the third call to the fourth call.

8. The method according to claim 7, further comprising:
determining the second dial number associated with the first dial number from the first association stored in the service node, and generating a fourth caller identification comprising the determined second dial number;
wherein the fourth caller identification is transmitted in the fourth call.

9. The method according to claim 7, further comprising:
storing at least one further association between the first dial number and a respective further second dial number assigned in the second mobile phone network, in the service node, wherein for each stored first association an association identifier is assigned;
wherein the second caller identification also comprises the association identifier;
wherein in the step of extracting also the association identifier is extracted from the destination dial number; and,
wherein in the step of generating the fourth caller identification the second dial number associated with the first dial number is determined by means of the first association identified by the extracted association identifier.

10. The method according to claim 7, wherein the third call directed to the second caller identification is detected by means of the network prefix of the second mobile network and directed thereto, where it is received at a line of the second mobile phone network and from there is connected to the fourth call.

11. The method according to claim 1, wherein the second associations stored in the service node for a first association are sent via a data connection to the mobile station and there are stored in a memory of the mobile station.

12. The method according to claim 11, further comprising:
extracting the reserve dial number from the second caller identification transmitted in a second call, in the mobile station;
determining the first caller identification associated with the extracted reserve call number in a second association from the memory; and,
indicating the first caller identification in the mobile station.

13. The method according to claim 1, wherein the second dial number was assigned in the second mobile phone network.

14. The method according to claim 1, wherein the second dial number was dial number ported from another mobile phone network into the second mobile phone network.

15. The method according to claim 1, wherein the second mobile phone network is virtualized as a Mobile Virtual Network Operator in a third mobile phone network.
